(19) United States
(12) Patent Application Publication
(10) Pub. No.: US 2013/0121102 A1
(43) Pub. Date: May 16, 2013

(54) EMULSIFIER, AND METHOD OF DERIVING PARAMETERS FOR AN EMULSIFIER

(71) Applicant: Kok Loon Ng, Singapore (SG)

(72) Inventor: Kok Loon Ng, Singapore (SG)

(73) Assignee: BLUE OCEAN SOLUTIONS PTE LTD, Singapore (SG)

(21) Appl. No.: 13/811,062

(22) PCT Filed: Jul. 20, 2011
(86) PCT No.: PCT/SG11/00259

§ 371 Date: Jan. 18, 2013

(30) Foreign Application Priority Data
Jul. 20, 2010 (SG) 201005265-2

(51) Int. Cl. G06F 17/50; B01F 3/08

(52) U.S. Cl. CPC G06F 17/5009; B01F 3/0865
USPC 366/173.2; 366/167.1; 703/2

(57) ABSTRACT

A method of deriving parameters for an emulsifier for producing specific water-in-fuel emulsions consistent with emulsions produced by a reference emulsifier is disclosed herein. In a described embodiment, the emulsifier and reference emulsifier includes a desired mixing chamber and reference mixing chamber respectively for mixing fuel and water. The method comprises, at steps 602 to 604, deriving a diameter of the desired mixing chamber for the emulsifier based on a diameter of the reference mixing chamber of the reference emulsifier, the derived dimension of the desired mixing chamber being one which creates a turbulent type flow at the mixing chamber. At step 605, the method includes calculating dimensionless water particle size from the derived dimension and at step 606, deriving nozzle dimension of the emulsifier for a plurality of water nozzles for injecting the water into the oil at the mixing chamber from the calculated dimensionless water particle size. Further the method includes deriving the number of water nozzles for the emulsifier at step 607.

### BACKGROUND AND FIELD OF THE INVENTION

The invention relates to an emulsifier and method of deriving parameters for an emulsifier.

Application of water-in-fuel emulsions to improve the combustion of diesel engines and boilers has been well established for many years. Well researched and published work on the combustion of water-in-fuel emulsion droplets explained that a reason for the improved combustion of emulsion is due to secondary microscopic explosion effect. FIG. 1a illustrates a magnified and simplistic view of a fuel droplet 102 under high pressure. The droplet 102 comprises water particles 101 in the fuel droplet 102 to form an emulsion and the secondary microscopic explosion effect is caused by explosive boiling 103 of the superheated microscopic water particles 101 in the fuel droplet 102 when it is injected into a combustion chamber of an engine or boiler, as illustrated in FIG. 1 b. FIG. 1c shows results of the secondary microscopic explosions of the water-in-fuel particles which create a finer fuel mist 104 and improve the mixing of fuel and air, resulting in better combustion.

It is preferred that the water-in-fuel emulsion has water content of between 6 and 40 percent by volume and uniformly distributed water particles of mean size of 2 to 6 microns. The main factors that affect the secondary microscopic explosion effect are (1) the amount of water content by volume in the fuel and (2) the mean size and the distribution of the water particles in the fuel.

Several conventional methods have been proposed for producing water-in-fuel emulsions. An example of one such conventional method is the use of mechanical shearing devices. Such devices consist of mechanical moving parts such as rotating meshed gears or rotating serrated surfaces to produce high shearing forces to break the water in the mixture of water and fuel to produce water-in-fuel emulsions.

Another method to produce water-in-fuel emulsions is to use ultrasound, or sound at a pitch above 18,000 cycles/sec (inaudible to the human ear). The fast and forceful vibrations break up both the water and the fuel into tiny droplets and intersperse them in each other to produce water-in-fuel emulsions.

Such prior art of producing water-in-fuel emulsions, however, suffer from a disadvantage that they have either moving mechanical parts, or electrical or electronic parts that require maintenance and replacement. In any case, such methods cannot produce water-in-fuel emulsions of desired water content and size reliably.

GB2233572 discloses an emulsifier which has no moving mechanical, electrical or electronic parts. An emulsifier is understood to be a device for producing water-in-fuel emulsions and an example of such an emulsifier is shown in FIG. 2, which is a cross-sectional view of the emulsifier 200. The emulsifier 200 comprises a set of nozzles 201, a mixing chamber 202 and a diffuser unit 203 with mixing plates 204. The emulsifier. 200 has a water inlet 205a and a fuel inlet 206a. Fuel is directed into the mixing chamber 202 via the fuel inlet 206a and water 205 is injected into the fuel 206 perpendicular to direction of the fuel at the mixing chamber 202 through the set of nozzles 201 at the peripheral of the mixing chamber 202 to produce the required water-in-fuel emulsions 207 at output 208 of the emulsifier. The mixing of water and fuel is caused by hydrodynamic shearing forces due to the exchange of momentum in the mixing chamber 202 between the fuel and perpendicular jets of water. Again, such an emulsifier cannot produce the desired water-in-fuel emulsions reliably.

It is an object of the invention to provide an emulsifier and a method of deriving parameters for an emulsifier which addresses the disadvantages of prior art and/or to provide the public with a useful choice.

### SUMMARY OF THE INVENTION

In accordance with a first aspect of the present invention, there is provided a method of deriving parameters for a desired emulsifier for producing specific water-in-fuel emulsions consistent with emulsions produced by a reference emulsifier. The desired emulsifier and reference emulsifier include a desired mixing chamber and reference mixing chamber respectively for mixing fuel and water. The method comprises:

(i) deriving a dimension of the desired mixing chamber for the desired emulsifier based on dimension of the reference mixing chamber of the reference emulsifier, the derived dimension of the desired mixing chamber being one which creates a turbulent type flow at the desired mixing chamber;

(ii) calculating dimensionless water particle size from the derived dimension;

(iii) deriving nozzle dimension of the desired emulsifier for a plurality of water nozzles for injecting the water into the fuel at the desired mixing chamber from the calculated dimensionless water particle size.

It should be understood that an emulsifier is a device for producing emulsions of water and fuel.

By using the proposed method as described in the preferred embodiment, it is possible to derive parameters for parts of the desired emulsifier so that the desired emulsifier produces water-in-fuel emulsions of a specific content, for example, specific water content and/or water particle sizes. For example, preferably, the desired emulsifier is adapted to produce water-in-fuel emulsions of water content of 6% to 40% (measured as percentage of water volume to fuel volume) and water particle sizes in the range of 2 to 6 microns based on fuel viscosity of about 2.8 to 24 centistokes when flowing through the emulsifier after heating, or preferably between 2.8 and 14 centistokes when flowing through the emulsifier after heating.

Preferably, step (i) further comprises (iv) calculating an initial dimension of the desired mixing chamber for the desired emulsifier based on dimension of the reference mixing chamber of the reference emulsifier, and (v) verifying if the initial dimension of the desired mixing chamber would create the turbulent-type flow at the desired mixing chamber. If the initial dimension would create the turbulent-type flow, the method may include using the initial dimension as the derived dimension.

On the other hand, if the dimension would not create a turbulent-type flow, the method may comprise (vi) revising the initial dimension and performing step (v) until a revised dimension is obtained which would create a turbulent-type flow at the desired mixing chamber; and using the revised dimension as the derived dimension.

Preferably, step (v) includes calculating respective Reynold number of fuel flow of the reference emulsifier and the desired emulsifier. The method may further comprise the step of checking the calculated Reynold numbers against a Moody Diagram to verify if the derived dimension would create a turbulent-type flow.

Step (iii) may include determining nozzle dimension ratio from an empirical dimension model of the reference emulsifier based on the calculated dimensionless water particle size.

The method may further comprise deriving the nozzle dimension from the determined nozzle dimension ratio and the derived dimension.

The empirical dimension model may include a chart of varying nozzle dimension ratios versus varying dimensionless mean water particle sizes derived from the reference emulsifier.

The reference dimension of the reference emulsifier may include diameter of the reference mixing chamber and fuel flow rate of the reference mixing chamber.

The derived dimension may include diameter of the desired mixing chamber of the desired emulsifier.

Advantageously, water content and water particle size of the emulsion to be produced by the desired emulsifier is consistent with those produced by the reference emulsifier. Preferably, the water content is between 6% and 40% as percentage of water volume to fuel volume and water particle sizes of substantially between 2 and 6 microns.

The method may further comprise deriving a number of water nozzles for the desired emulsifier.

To simplify the process, the result from the above methods may be embodied as a reference parameter map and this provides a second aspect of the invention which provides a method of determining parameters for a desired emulsifier for producing specific water-in-fuel emulsions with an intended fuel flow-rate from a reference parameter map. The reference parameter map is derived from the above method and comprises a plurality of values of dimensions of the desired mixing chamber and corresponding values of desired water nozzles dimensions at respective desired fuel-flow rates. The method comprises identifying one of the desired fuel-flow rates which corresponds to the intended fuel flow-rate, obtaining corresponding values of the dimensions of the desired mixing chamber and desired water nozzles from the identified fuel-flow rate; and using these corresponding values as the parameters for the desired emulsifier.

The identifying step may include interpolating between two desired fuel-flow rates to identify an interpolated fuel-flow rate which corresponds to the intended fuel flow-rate; and obtaining corresponding values of the dimensions of the desired mixing chamber and desired water nozzles from the interpolated fuel-flow rate.

As explained above, based on the above methods, a desired emulsifier with a reliable and predetermined output may be obtained and the third aspect of the invention relates to such a device. Accordingly, there is provided an emulsifier for producing water-in-fuel emulsions, comprising a mixing chamber for mixing fuel and water; the mixing chamber having a diameter of between about 8.00 mm and about 47 mm; a fuel inlet for directing fuel into the mixing chamber at a rate of about 0.60 m³/hr to about 108 m³/hr; and one or more nozzles arranged to receive water from a water inlet and to inject the water into the mixing chamber; the or each nozzle having a diameter of between about 0.50 mm and 6.60 mm.

The emulsifier may be adapted to produce water-in-fuel emulsions with water particles sizes between 6% and 40% (and preferably between 6% and 12%) as percentage of water volume to fuel volume and water particle sizes of substantially between 2 and 6 microns. The mixing chamber may have a diameter of about 8.00 mm, the or each water nozzle may have diameter of about 0.50 mm and the fuel inlet may be arranged to direct fuel into the mixing chamber at a rate of about 0.60 m³/hr.

Further variations of the parameters are:

The mixing chamber may have a diameter of about 10.00 mm, the or each water nozzle may have diameter of 1.10 mm and the fuel inlet may be arranged to direct fuel into the mixing chamber at a rate of about 3.00 m³/hr.

The mixing chamber may have a diameter of about 12.00 mm, the or each water nozzle may have diameter of 1.55 mm and the fuel inlet may be arranged to direct fuel into the mixing chamber at a rate of about 6.00 m³/hr.

The mixing chamber may have a diameter of about 14.00 mm, the or each water nozzle may have diameter of 1.90 mm and the fuel inlet may be arranged to direct fuel into the mixing chamber at a rate of about 9.00 m³/hr.

The mixing chamber may have a diameter of about 16.00 mm, the or each water nozzle may have diameter of 2.20 mm and the fuel inlet may be arranged to direct fuel into the mixing chamber at a rate of about 12.00 m³/hr.

The mixing chamber may have a diameter of about 18.00 mm, the or each water nozzle may have diameter of 2.50 mm and the fuel inlet may be arranged to direct fuel into the mixing chamber at a rate of about 15.00 m³/hr.

The mixing chamber may have a diameter of about 19.00 mm, the or each water nozzle may have diameter of 2.70 mm and the fuel inlet may be arranged to direct fuel into the mixing chamber at a rate of about 18.00 m³/hr.

The mixing chamber may have a diameter of about 21.00 mm, the or each water nozzle may have diameter of 2.95 mm and the fuel inlet may be arranged to direct fuel into the mixing chamber at a rate of about 21.00 m³/hr.

The mixing chamber may have a diameter of about 26.00 mm, the or each water nozzle may have diameter of 3.70 mm and the fuel inlet may be arranged to direct fuel into the mixing chamber at a rate of about 33.00 m³/hr.

The mixing chamber may have a diameter of about 35.00 mm, the or each water nozzle may have diameter of 4.95 mm and the fuel inlet may be arranged to direct fuel into the mixing chamber at a rate of about 60.00 m³/hr.

The mixing chamber may have a diameter of about 47.00 mm, the or each water nozzle may have diameter of 6.60 mm and the fuel inlet may be arranged to direct fuel into the mixing chamber at a rate of about 108.00 m³/hr.

Preferably, the emulsifier includes four water nozzles. Preferably, the fuel has a viscosity of 2.8 centistokes to 24 centistokes measured after heating.

According to a fourth aspect, there is provided a method of designing and sizing the parts of the desired emulsifier to produce water-in-fuel emulsions more particularly but not exclusively, of water content in the range of 6% to 40% and water particle sizes of 2 to 6 microns, the method comprising the steps of deriving the design and sizes of the parts of the desired emulsifier from a reference emulsifier which has been tested and verified to produce water-in-fuel emulsions of water content in the range of 6% to 40% and water particle sizes of 2 to 6 microns.

It should be appreciated that features of one aspect may also be applicable to another aspect.

### BRIEF DESCRIPTION OF THE DRAWINGS

An example of the invention will now be described with reference to the accompanying drawings, in which:

FIG. 1a illustrates a simplified enlarged view of a water-in-fuel particle;

FIG. 1b illustrates secondary microscopic explosion effect of the water-in-fuel particle when the particle is heated to a high temperature and injected into a combustion chamber of an engine;

FIG. 1c illustrates results of the secondary microscopic explosion effect which create finer fuel sprays and better mixture of fuel and air for combustion;

FIG. 2 shows a schematic representation of an emulsifier for producing water-in-fuel emulsions, comprising a mixing chamber, water nozzles, a diffuser and mixing plates;

FIG. 3 is a pictorial diagram illustrating how an empirical dimensional model derived from a reference emulsifier is used to derive parameters for a desired emulsifier;

FIG. 4 is a graph showing the derived empirical dimensional model of the reference emulsifier of FIG. 3 which was tested and verified to produce water-in-fuel emulsions of water content of 6 to 40% by volume and water particle sizes of 2 to 6 microns;

FIG. 5a shows a typical picture of magnified water-in-fuel particles produced by the reference emulsifier of FIG. 3;

FIG. 5b is a graph showing measurements of sizes and distribution of the water particles of FIG. 5a;

FIG. 6 is a flow chart illustrating steps of a method to use the empirical dimensional model of FIG. 4 to derive parts of the desired emulsifier to produce water-in-fuel emulsions of specific water content and water particle sizes;

FIG. 7 illustrates a typical Moody diagram which is used to determine if fuel flows of the reference and desired emulsifiers of FIG. 3 are both in the turbulent flow region;

FIG. 8 is a table or map which provides calculated sizes of selected parameters of the desired emulsifier, namely mixing chamber diameters and water nozzle diameters derived using the method of FIG. 6 for varying fuel flow rates and four water nozzles;

FIG. 9 is a graphical representation of the values of the mixing chamber diameters of FIG. 8 versus the varying fuel flow rates;

FIG. 10 is a graphical representation of the values of the water nozzle diameters of FIG. 8 versus the varying fuel flow rates; and

FIG. 11 is a graphical representation of the values of the mixing chamber diameters versus the water nozzle diameters of FIG. 8.

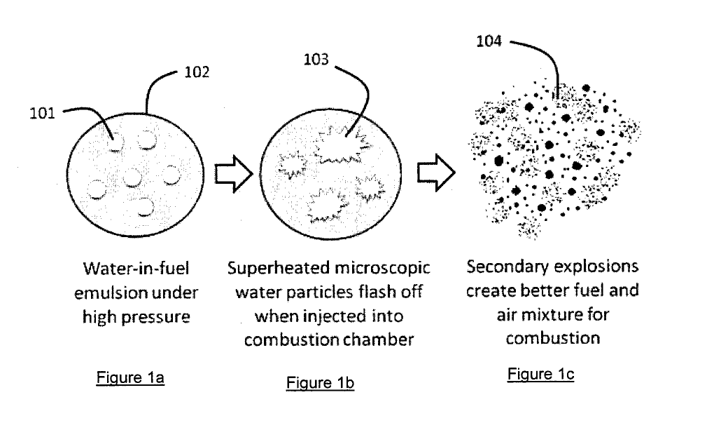

### DETAILED DESCRIPTION OF PREFERRED EMBODIMENT

The following definitions will be used throughout these specifications:

Water-in-fuel emulsions—means a mixture of water and fuel in such a way that the fuel droplets have many small water particles evenly distributed in the fuel.

Emulsifier—means a mixing device that mixes the water and fuel to produce the water-in-fuel emulsions

Reference emulsifier—means the emulsifier which is tested and verified to produce the water-in-fuel emulsions of the specified water content and water particle sizes

Desired emulsifier—means an emulsified which is to be designed and sized to produce the same water-in-fuel emulsions as that produced by the reference emulsifier

Water nozzles—means the part of the emulsifier from which high pressure and high velocity water jets are injected into the fuel at the mixing chamber of the emulsifier

Water content—means the amount of water by volume in the fuel and is measured as percentage of water by volume in the fuel.

Water particle size—means the diameter of the size of water particle in the fuel

Mixing Chamber—means the part of the emulsifier at which the fuel flows through and at which water jets are injected and mixed with the fuel to produce the water-in-fuel emulsions.

Parts of emulsifier—means the mixing chamber, the water nozzles, number of water nozzles, diffuser and mixing plates of the emulsifier

Density—means a physical property measured as the mass per unit volume (kg per m³)

Viscosity—means the measure of a fluid's resistance to flow and is measured at particular temperature in centistokes. The viscosity of a fluid is temperature dependent.

Surface tension—means the measurement of the cohesive energy present at the surface of a fluid

Dimensionless ratio—means the numerical ratio that is constructed so that it does not have any dimensions like weight, length or time.

Dimensional analysis—means a method used to check the plausibility of derived dependencies or relationships. It is also used to form reasonable hypotheses about complex physical processes that can be tested by experiments, and to categorize types of physical quantities and units based on their relations to or dependence on other units, or their “dimensions”, or their lack thereof.

Dimensional model—means the empirical dependencies, relationships or hypotheses of complex physical processes derived using dimensional analysis.

Reynold number—means a dimensionless ratio that is used in fluid mechanics to determine the similarity of flow conditions between different flow cases.

Moody diagram—means a dimensionless chart that is used to determine the similarity of flow between different flow cases from the Reynold number of the flow cases for surfaces of similar roughness.

Turbulent flow—means the flow condition of a fluid that is characterized by chaotic and random property changes

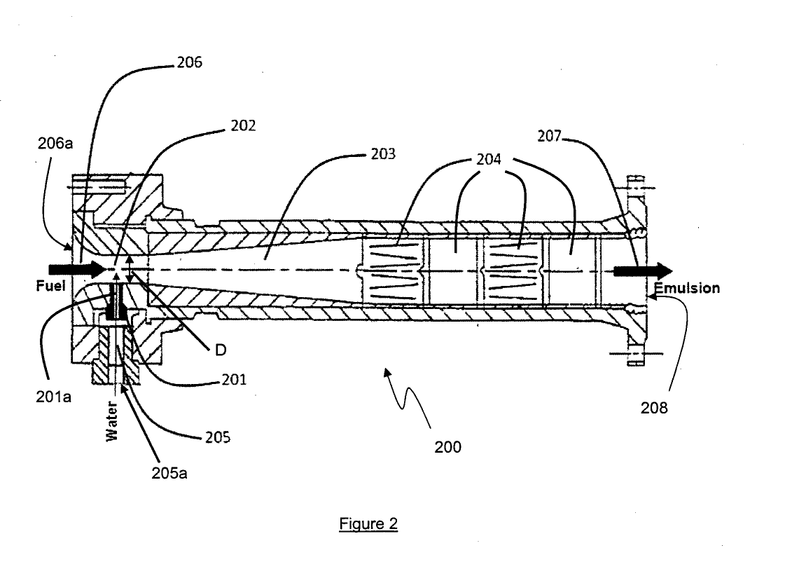

As explained earlier, the emulsifier 200 of FIG. 2 is configured for producing water-in-fuel emulsions but it does not produce the desired water content and water particle sizes accurately and reliably. In other words, the configuration of the emulsifier 200 is produced by trial and error which is time consuming, costly and inflexible. In this embodiment, an example will be explained to illustrate how to derive parameters of the emulsifier 200 so that the desired water content and water particle sizes may be predetermined and the content of GB2233572 is incorporated herein by reference to provide background information to understand the workings of an emulsifier (or apparatus for producing water-in-fuel emulsions).

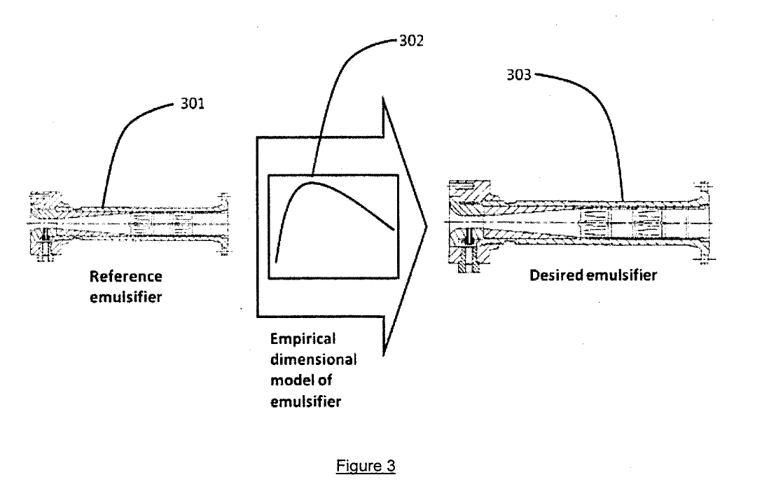

It would be appropriate to begin with an explanation of the technical background in order to appreciate the importance and effects of the described embodiment, in particular how to derive parameters of a desired emulsifier 303 from a reference emulsifier 301 (see FIG. 3). Both the desired emulsifier 303 and the reference emulsifier 301 have similar configurations as the emulsifier 200.

It can be appreciated that parameters that may possibly influence the type of water-in-fuel emulsions produced by the emulsifier 200 are:
a) fuel flow velocity V_{f}
b) water flow velocity V_{w}
c) number of water nozzles, k
d) diameter of the water nozzles, d
e) diameter of the mixing chamber, D
f) viscosity of fuel, μ_{f}
g) viscosity of water, μ_{w}
h) density of fuel, ρ_{f}
i) density of water, ρ_{w}
j) surface tension of water in fuel, s
k) percentage by volume of water to fuel, n
l) mean water particle size in micron, p

Using dimensional analysis methods (available from books such as (1) Fundamentals of Fluid Mechanics by Bruce R. Munson, Donald F. Young and Theodore H Okiishi; published by John Wiley & Sons Inc (2) Mechanics of Fluids by Massey B.S.; published by Van Nostrand Reinhold Co), the parameters that can possibly influence the performance of the emulsifier to produce water-in-fuel emulsions of specified water content and water particle sizes are expressed as the following dimensionless ratios:
a) dimensionless mean water particle size, p/D
b) fuel Reynold number, (p_{f} V_{f} D)/μ_{f}
c) nozzle dimension ratio, d/D
d) velocity ratio, V_{w}/V_{f}
e) Weber number, σ/(ρ_{f} D V_{f}²)
f) Relative density, ρ_{f}/ρ_{w}
g) Viscosity ratio, μ_{f}/μ_{w}

For complete similar performance between two emulsifiers of different sizes to produce the same water-in-fuel emulsions of specified water content and water particle sizes, the values of all the above dimensionless ratios must be same/identical for both emulsifiers.

It is appreciated that the densities and the viscosities of water and fuel used by the reference emulsifier and the desired emulsifier may be selected to be the same. It is also known that the surface tension effect on the water particle size is of secondary importance and may be ignored. Therefore, the effects of the dimensionless ratio of Weber number, relative density and viscosity ratio on the performance of the desired emulsifier in producing water-in-fuel emulsions may be ignored.

The velocity ratio V_{w}/V_{f} may be expressed in terms of the percentage water content by volume and the nozzle dimension ratio d/D and number of water nozzles, k, as shown below:

The percentage water by volume in the emulsion, n, is expressed as

$$\begin{matrix}n = \frac{k π ( {d}^{2} {V}_{w )} / 4}{π ( {D}^{2} {V}_{f )} / 4} \\ = {k ( d / D )}^{2} ( {V}_{w} / {V}_{f} )\end{matrix}$$

Hence, (V_{w}/V_{f}) can be expressed in terms of the percentage water content n, the nozzle dimension ratio (d/D) and the number of water nozzles, k. From this, it is appreciated that the velocity ratio is a redundant dimensionless ratio and its effect on the performance of the emulsifier may also be ignored.

From experiments conducted, it has been found that the number of water nozzles k and the percentage of water to fuel in the range of 6% to 40% by volume have negligible influence on the sizes of the water-in-fuel particles produced by the emulsifier 200. Therefore, it is appreciated that the number of water nozzles, k, may be ignored.

Unpredictably, it has been found that three dimensionless ratios may possibly influence the type of water-in-fuel emulsions produced by the emulsifier and they are:
a) dimensionless mean water particle size, p/D
b) fuel Reynold number, (ρ_{f} V_{f} D)/μ_{f}
c) nozzle dimension ratio, d/D

Therefore, for complete similar performance between two emulsifiers (e.g. reference and desired emulsifiers 301,303) of different sizes so that they both produce similar water-in-fuel emulsions of specified water content and water particle sizes, the values of the above three dimensionless ratios should be the same for both emulsifiers.

With the above as background, a method will now be described to derive parameters for the desired emulsifier 303.

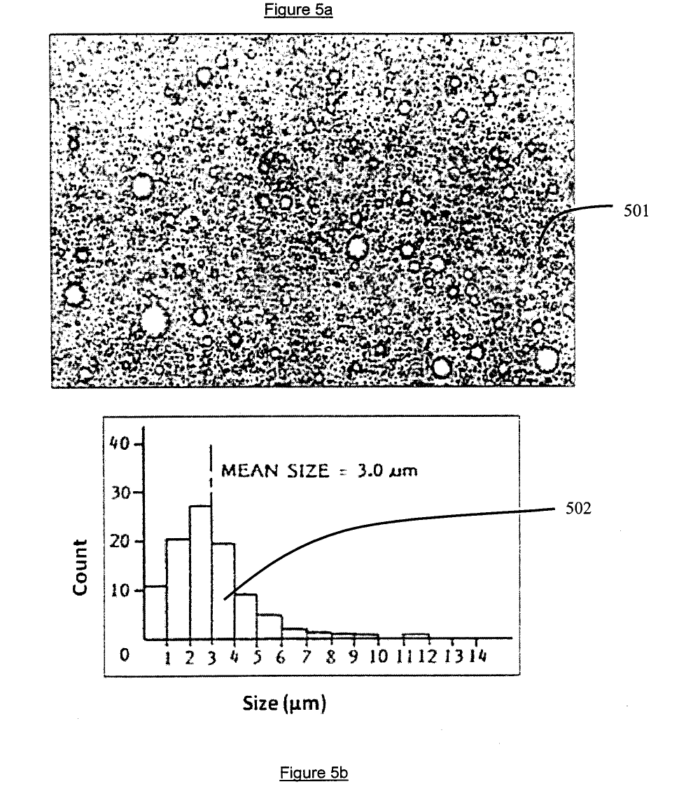

As illustrated in FIG. 3, to know selected parameters for the desired emulsifier 303, an empirical dimensional model 302 is used and the model 302 is derived from a reference emulsifier 301. In this embodiment, the reference emulsifier 301 is tested experimentally and verified to produce water-in-fuel emulsions of water content in the range of 6% to 40% (measured as percentage of water volume to fuel volume) and water particle sizes of 2 to 6 microns and then the reference emulsifier 301 is used to produce the empirical dimensional model 302. The fuel viscosity is about 2.8 to 24 centistokes (more preferably between 2.8 and 14 centistokes) and an example of fuel is oil. FIG. 5a is a magnified view of water-in-fuel particles 501 produced by the reference emulsifier 301 and FIG. 5b is a graph 502 showing measurements of sizes and distribution of the water particles in the fuel of FIG. 5a.

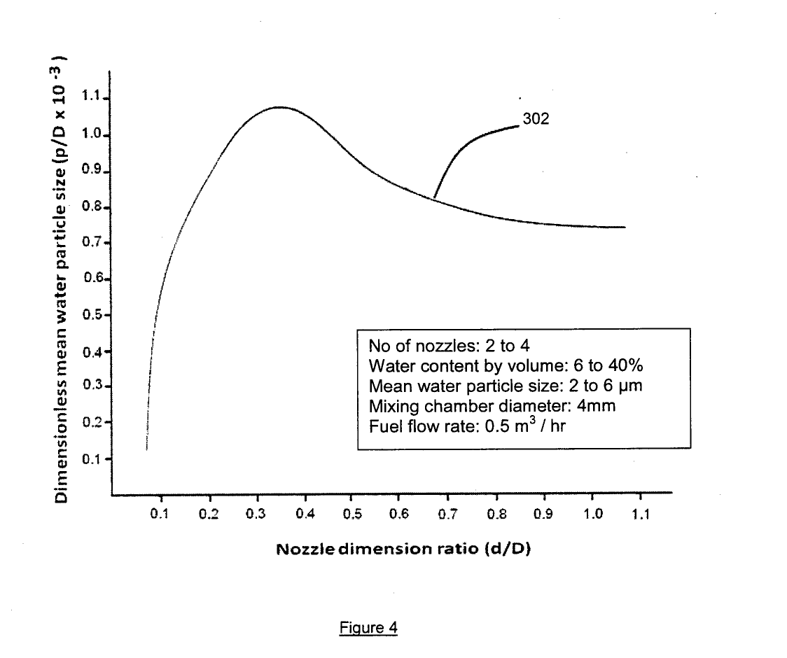

As shown in greater detail in FIG. 4, the model 302 includes a graph or chart of dimensionless mean water particle size against nozzle dimension ratio. The dimensionless mean water particle size is the ratio of the mean water particle size 502 to that of the diameter D of the mixing chamber 202 (see FIG. 2). The nozzle dimension ratio is a ratio of the water nozzle diameter 201a (“d”) to that of the diameter D of the mixing chamber 202.

In this embodiment, the reference emulsifier has 4 nozzles and the diameter D of the mixing chamber is 4 mm with a fuel flow rate of 0.5 m³/hr into the mixing chamber and is configured to produce water content by volume of 6 to 40% and mean water particle size of 2 to 6 microns. Based on these parameters, the model 302 of FIG. 4 is obtained and is then used to derive parameters for the desired emulsifier 303 to produce water-in-fuel emulsions of water content in the range of 6% to 40% and water particle sizes of 2 to 6 microns which is consistent with the output from the reference emulsifier.

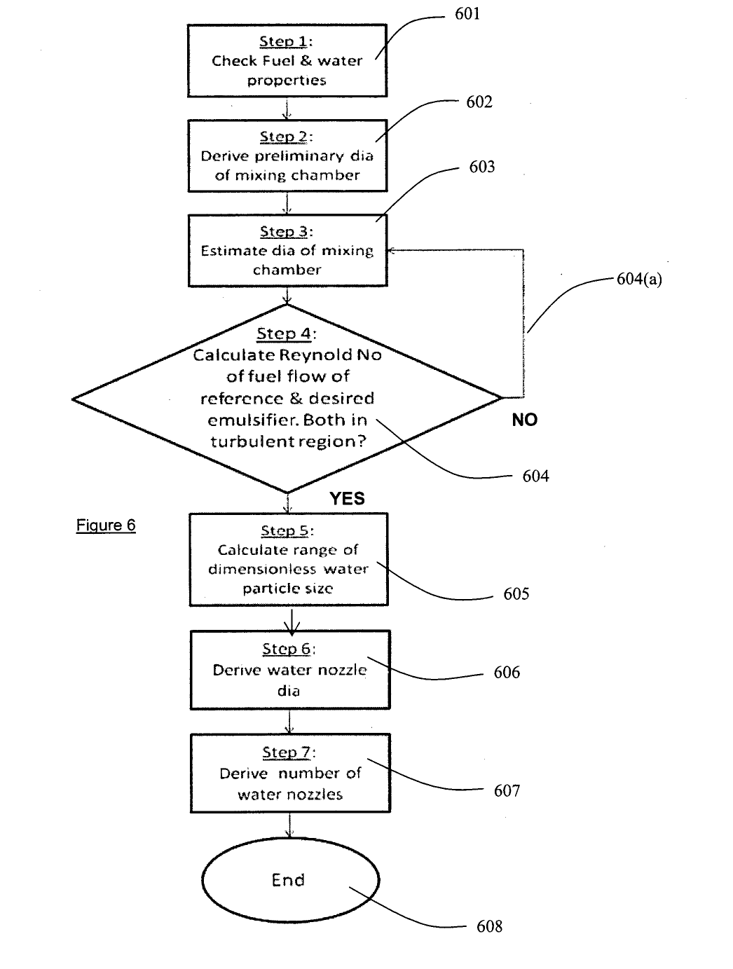

FIG. 6 is a flow chart illustrating steps of how to use the empirical dimensional model 302 of the reference emulsifier 301 to derive parameters of the desired emulsifier 303 to produce water-in-fuel emulsions of specific water content and water particle sizes as discussed above.

At step 601, properties of the fuel and water used by the reference emulsifier are ascertained and recorded so that these properties are used later for the desired emulsifier when the latter is made. In this embodiment, these properties are density, viscosity and surface tension.

At step 602, a preliminary diameter D_{desired} of the mixing chamber 202 of the desired emulsifier 303 is derived from the formula:

D_{desired}=D_{reference}×(Q_{desired}/Q_{reference}) (1)
where
   D_{reference} is a diameter of the mixing chamber of the reference emulsifier;
   Q_{desired} is an intended fuel flow rate of the desired emulsifier; and
   Q_{reference} is a fuel flow rate of the reference emulsifier.

At step 603, a first estimated diameter of the mixing chamber 202 is determined by selecting a most practical size that can be manufactured using the preliminary diameter D_{desired} calculated at step 602. Of course, if it is practical to manufacture the desired emulsifier based on the preliminary diameter D_{desired}, then the estimation to obtain the first estimated diameter may not be performed.

At step 604, the Reynold numbers of both the fuel flows in the reference emulsifier 301 and the desired emulsifier 303 are derived from the following formulae

Reynold number of reference emulsifier,Re_{reference}=(ρ_{fr}V_{fr}Dᵣ)/μ_{fr} (2)

where
ρ_{fr} is density of fuel used with the reference emulsifier;
V_{fr} is velocity of the fuel flow at the mixing chamber of the reference emulsifier;
Dᵣ is diameter of the mixing chamber of the reference emulsifier;
μ_{fr} is viscosity of fuel used in the reference emulsifier.

Reynold number of desired emulsifier, Re_{desired}=(ρ_{fd}V_{fd}D_{d})/μ_{fd} (3)

where
ρ_{fd} is density of fuel to be used with the desired emulsifier;
V_{fd} is velocity of the fuel flow to be used at the mixing chamber of the desired emulsifier 303;
D_{d} is the diameter of the mixing chamber of the desired emulsifier 303;
μ_{fd} is viscosity of fuel to be used with the desired emulsifier 303.

It should be appreciated that D_{d} of formula (3) is the same as the first estimated diameter determined at step 603.

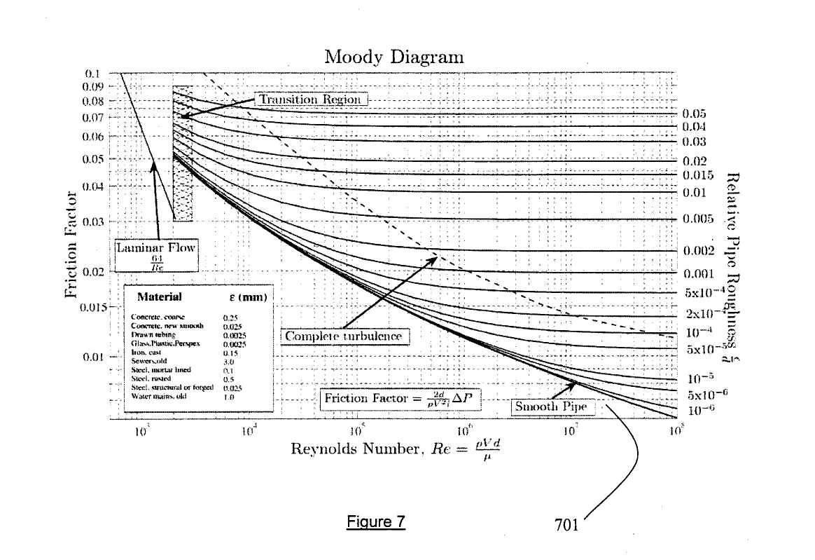

Both Reynold numbers Re_{reference} and Re_{desired} are then checked against a standard Moody Chart 701 which is illustrated in FIG. 7. (The explanations of Reynold number, Moody Chart and their use are published in standard technical text books on Fluid Mechanics. Examples of such books are (1) Fundamentals of Fluid Mechanics by Bruce R. Munson, Donald F. Young and Theodore H Okiishi; published by John Wiley & Sons Inc (2) Mechanics of Fluids by Massey B.S.; published by Van Nostrand Reinhold Co) If both the Reynold numbers Re_{reference} and Re_{desired} are in the turbulent flow region then the first estimate of the diameter of the mixing chamber obtained at step 603 can be used. If not, the method flows back (as shown by error 604(a)) to step 603 to obtain a second estimated diameter of the mixing chamber of the desired emulsifier 303 which is suitable for manufacturing and is the next closest to the preliminary diameter D_{desired}. With the second estimated diameter, step 604 is repeated to obtain a revised Re_{desired} and then both the Re_{reference} and the revised Re_{desired} are checked against the Moody Diagram to determine if the numbers fall within the turbulent region. As it can be appreciated, steps 603 and 604 are repeated, as appropriate, until both Reynold numbers of the reference emulsifier and the desired emulsifier 303 are in the turbulent flow region, and let's select D_{d(turbulent)} to be the diameter of the mixing chamber of the desired emulsifier obtained after step 604 (i.e. D_{d(turbulent}) gives Re_{desired} which falls within the turbulent region of the Moody Diagram.)

It should be appreciated that in practice, the Re_{reference} would already have been obtained and checked that it falls within the “turbulent” region and thus, step 604 need not calculate the Re_{reference} or check it against the Moody Diagram. In other words, step 604 may just calculate Re_{desired} only and compare it against the Moody Diagram of FIG. 7.

At step 605 the range of the dimensionless mean water particle size is calculated from the formula:

$$Dimensionless mean water particles size , \\ {( \frac{p}{D} )}_{desired} = p / {D}_{d ( turbulent )} \qquad ( 4 )$$

where
p is the mean water particle size, and in this embodiment, the target or desired mean water particle size is between 2 and 6 microns;
D_{d(turbulent)} is the diameter of the mixing chamber of the desired emulsifier derived from step 604

At step 606, with the dimensionless mean water particle size

$$( \frac{p}{D} )$$

_{desired} obtained from step 605, a corresponding water nozzle dimension ratio

$$( \frac{d}{D} )$$

_{desired} is read off from the chart of the empirical dimensional model 302 of FIG. 4.

With the water nozzle dimension ratio

$$( \frac{d}{D} )$$

_{desired} known, the estimated nozzle diameter of the desired emulsifier is then calculated from the formula:

$$Estimated nozzle diameter , \\ {d}_{desired} = ( nozzle dimension ratio , {( \frac{d}{D} )}_{desired} ) \times {D}_{d ( turbulent )} \qquad ( 5 )$$

where
nozzle dimension ratio,

$$( \frac{d}{D} )$$

_{desired} is obtained from the dimensional model chart for the desired dimensionless water particle size (p/D) as explained above;
D_{d(turbulent)} is the diameter of the mixing chamber of the desired emulsifier 303.

The estimated nozzle diameter, d_{desired} may not be practical to manufacture and if this is the case, then an adjustment is made by selecting a practical nozzle diameter for use which is closest to the estimate nozzle diameter d_{desired} and which can be manufactured.

At step 607, a number of water nozzles for the desired emulsifier 303 is determined by calculating that pressure losses across the water nozzles using standard text book methods of calculating pressure losses. (Examples of such books are (1) Fundamentals of Fluid Mechanics by Bruce R. Munson, Donald F. Young and Theodore H Okiishi; published by John Wiley & Sons Inc (2) Mechanics of Fluids by Massey B.S.; published by Van Nostrand Reinhold Co) The purpose is to check that there are off-the shelf high pressure pumps which can provide the water pressures required to deliver the amount of water needed by the desired emulsifier. It should be mentioned that the number of water nozzles may be derived independently (and separately) from the estimated nozzle diameter d_{desired} since the number of water nozzles are dependent on the desired flow rate and pressure losses as mentioned above. However, in deriving the number of water nozzles, consideration may be given to the estimated nozzle diameter d_{desired} since if the nozzle diameter is small, more nozzles may be selected.

The method ends at step 608 and it can be appreciated that the diameter of the mixing chamber, the water nozzle diameter and the number of nozzles of the desired emulsifier 303 to produce the water-in-fuel emulsions of the specified water content and water particle sizes have been derived.

As it can be appreciated, the described embodiment enables selected parameters for the desired emulsifier to be determined which would produce emulsions of a specific water content and water particle sizes. By ensuring that the Reynold numbers of the reference emulsifier and the desired emulsifier are in the same turbulent region, the relationship between the dimensionless mean water particle size, p/D and the nozzle dimension ratio d/D in the form of the chart as shown in FIG. 4 may be determined experimentally for the reference emulsifier which produced water-in-fuel emulsions of the specified water content and water particle sizes.

A specific example of how to derive parameters (or design and sizing of the parts) of a desired emulsifier 303 will now be explained.

Consider a case where the desired emulsifier 303 is required to produce water-in-fuel emulsions of water content 10% by volume and water particle size of 2 to 6 microns at a fuel flow rate of 3 m³/hour. The empirical dimensional model 302 of the reference emulsifier that produce water-in-fuel emulsions of water content 10% by volume and water particle size of 2 to 6 microns was derived experimentally and is shown in FIG. 4. The reference emulsifier has a mixing chamber of diameter 4 mm and was tested with fuel flow rate of 0.5 m³/hour.

At step 601 of FIG. 6, the fuel and water properties of the reference 301 are recorded for use later with the desired emulsifier 303.

At step 602, the preliminary diameter D_{desired} of the mixing chamber is derived from the formula (1) and this is 24 mm (i.e. =4×(3/0.5)).

At step 603, it is determined that the preliminary diameter D_{desired} of 24 mm may be selected for the diameter of the mixing chamber of the desired emulsifier. We shall consider D_{desired} of 24 mm and proceed to step 604.

At step 604, the Reynold numbers of both the reference emulsifier and desired emulsifier Re_{reference} and Re_{desired} are derived and checked using the Moody diagram illustrated in FIG. 7.

The Reynold number of the reference emulsifier 303 for fuel flow in the reference mixing chamber using formula (2) is 11,060 which is in the turbulent region of the Moody diagram. The Reynold number of the desired emulsified emulsifier with mixing chamber of diameter 24 mm using formula (2) is 3,160 which is in the transient laminar—turbulent region of the Moody diagram. From manufacturing perspective, it is possible to reduce the diameter of the desired mixing chamber and increase the Reynold number. The smallest practical diameter of the desired mixing chamber that can be manufactured is 10 mm. The Reynold number of the desired emulsifier with diameter of mixing chamber of 10 mm, is 7580 which is in the turbulent region of the Moody diagram. So the diameter of the mixing chamber is confirmed to be 10 mm, which is D_{d(turbulent)}.

Next, at step 605, the range of the dimensionless mean water particle size for water particle size

$$( \frac{p}{D} )$$

_{desired} of 2 to 6 microns is calculated from the formula (4). In this embodiment, for this range of desired mean water particle sizes, the dimensionless mean water particle size has been found to range between about 0.2×10⁻³ and about 0.6×10⁻³.

At step 606, the corresponding water nozzle dimension ratio

$$( \frac{d}{D} )$$

_{desired} is read off from the chart of the empirical dimensional model 401 of FIG. 4 and it is about 0.07 to 0.11. With

$$( \frac{d}{D} )$$

_{desired}, the estimated nozzle diameter of the desired emulsifier d_{desired} is then calculated from the formula (5) and the estimated nozzle diameter is 0.9 to 1.1 mm

$$( i . e . = {( \frac{d}{D} )}_{desired} \times 10.0 )$$

The actual diameter is selected to be 1.1 mm which is the most practical size.

At step 607, after checking for pressure losses at the water nozzles, a set of 4 nozzles is selected to deliver 0.1 m³/hour of water through 4 water nozzles of diameter 1.1 mm.

The water flow rate is obtained from 10% of the fuel consumption rate which is about ⅓ of the fuel flow rate of 3 m³/hr.

In summary, the configuration and sizes of the desired emulsifier are (1) diameter of mixing chamber is 10.0 mm (2) the diameter of the water nozzles is 1.1 mm (3) the number of water nozzles is 4.

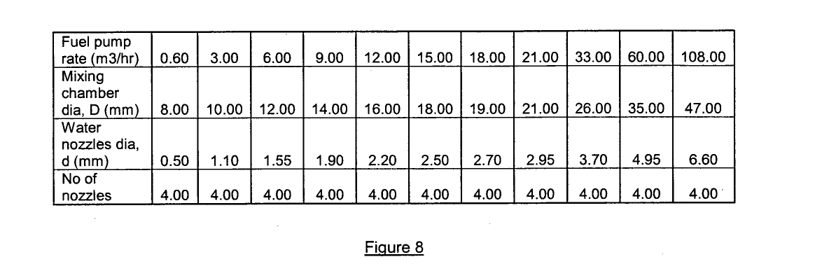

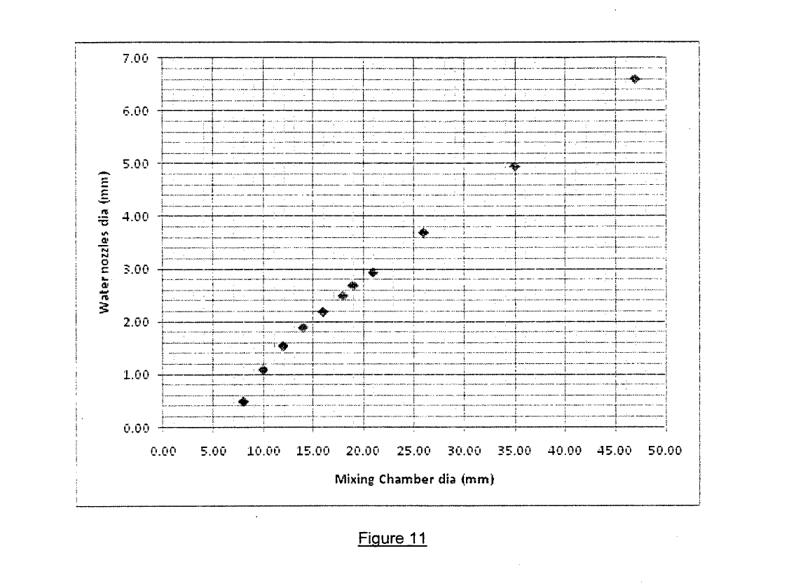

As it can be appreciated from the above, the proposed method enables certain selected parameters, namely the mixing chamber diameter D_{d(turbulent} (or generally D) (mm), the water nozzles diameter d (mm) and the number of water nozzles of the desired emulsifier to be calculated and the results are illustrated by FIGS. 8 to 11 for fuel flow rate range of 0.6 m/s to 108 m/s and fuel with viscosity of 2.8 centistokes to 24 centistokes (during flow after heating).

FIG. 8 is a table or map which provides calculated sizes of selected parameters of the desired emulsifier, namely mixing chamber diameters D (mm) and water nozzle diameters (mm) derived using the method of FIG. 6. The values are derived based on varying fuel flow rates of 0.6 m/s to 108 m/s and for four water nozzles, and are selected to produce a range of 6% to 40% of water volume to fuel volume and water particle sizes of 2 to 6 microns.

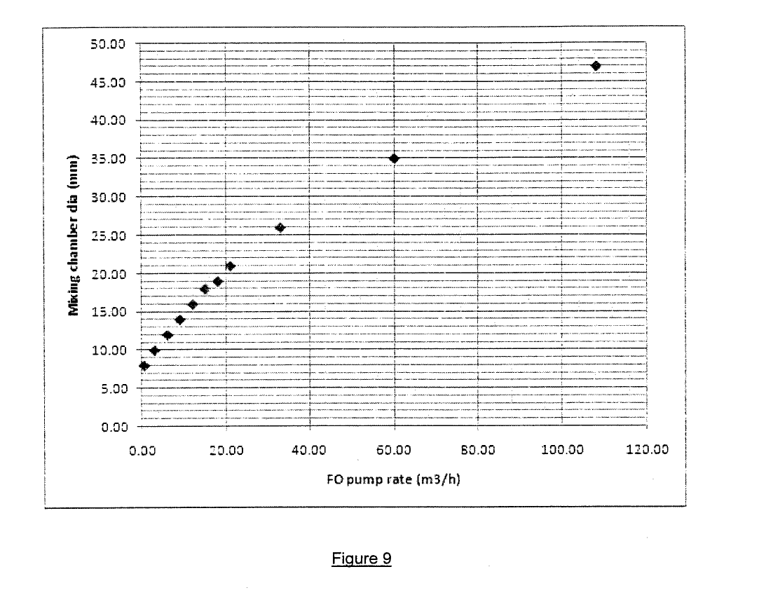

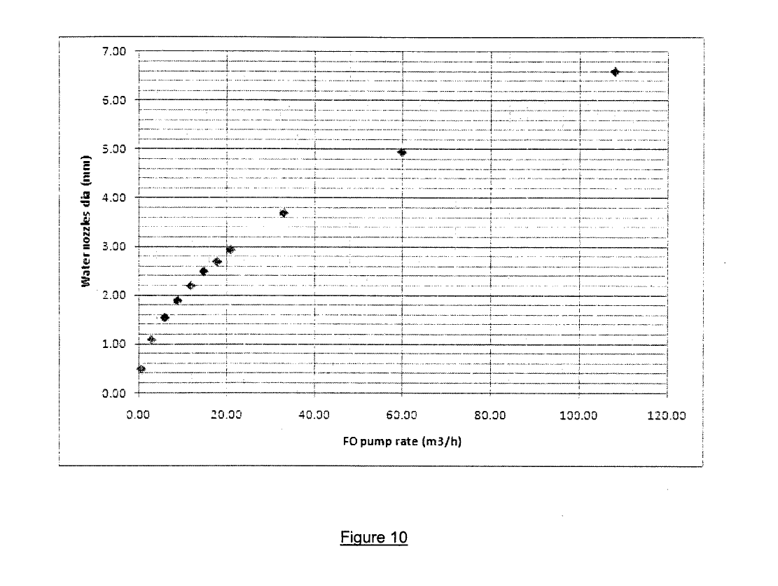

FIG. 9 is a graphical representation of the values of the mixing chamber diameters of FIG. 8 versus the varying fuel flow rates of 0.6 m/s to 108 m/s of FIG. 8 to show the relationship between these two parameters. FIG. 10 is a graphical representation of the values of the water nozzle diameters of FIG. 8 versus the varying fuel flow rates of 0.6 m/s to 108 m/s also to show the relationship between these two parameters. Further, 11 is a graphical representation of the values of the mixing chamber diameters and the water nozzle diameters of FIG. 8.

The fuel flow rate range of 0.6 m/s to 108 m/s covers the fuel flow rate range of the fuel oil system of most ships for maritime application. The fuel flow rate is generally that provided by a fuel pump which is generally, designed to provide fuel flow rate of 3 to 3.5 times that of the maximum fuel consumption of a ship's engine served by the fuel oil system. It should be noted that the order of variation of the selected parameters calculated using the claim method may be:
+/−1 mm for mixing chamber diameter, D
+/−0.1 mm for the water nozzle diameter d

Using FIGS. 8 to 11, the designed parameters, namely the mixing chamber diameter, D (mm), the water nozzles diameter d (mm) and the number of water nozzles, of the emulsifier may be obtained based on the fuel flow rate of the fuel oil service system. For fuel flow rates between points in FIGS. 8 to 11, the parameters, namely the mixing chamber diameter, D (mm) and the water nozzles diameter d (mm) for 4 water nozzles may be obtained by interpolating between the points.

Consider a case where the desired emulsifier 303 is required to produce water-in-fuel emulsions of water content in the range of 6% to 40% by volume and water particle size of 2 to 6 microns at a maximum fuel rate of 12 m³/hr for fuel of viscosity of 14 centistokes when flowing through the emulsifier after the fuel has been heated up. The empirical dimensional model 302 of the reference emulsifier that produce water-in-fuel emulsions of water content 10% to 40% by volume and water particle size of 2 to 6 microns was derived experimentally and shown in FIG. 4. The reference emulsifier has a mixing chamber of 4 mm and was tested with fuel flow rate of 0.5 m³/hr.

Using FIG. 8 to FIG. 11 which are derived using the claimed method, the parameters of the desired emulsifier 303 which would produces the desired water-in-fuel emulsions are:
The diameter of the mixing chamber of the desired emulsifier is 16 mm
The diameter of the water nozzles of the desired emulsifier is 2.2 mm
The number of water nozzles is four (4)

The above selected parameters from FIGS. 8 to 11 ensures that the fuel flow in the mixing chamber of the desired emulsifier is turbulent and that the desired emulsifier will have similar performance to that of the reference emulsifier in producing water-in-fuel emulsions of water content of 10% to 40% by volume and water particle size of 2 to 6 microns at a maximum flow rate of 12 m³/hr for fuel of viscosity of 14 centistokes when flowing through the emulsifier after been heated up.

As it can be appreciated from the above, the proposed method enables certain selected parameters, namely the mixing chamber diameter D_{d(turbulent)} (or generally D) (mm), the water nozzles diameter d_{desired} (or generally d) (mm) and the number of water nozzles of the desired emulsifier to be calculated and the results are illustrated by FIGS. 8 to 11 for fuel flow range of 0.6 m/s to 108 m/s and fuel with viscosity of 2.8 centistokes to 24 centistokes (during flow after heating). In this way, it makes designing and manufacturing the desired emulsifier 303 much easier and simpler.

The described embodiment is not to be construed as limitative. For example, in the described embodiment, FIG. 6 includes steps 601 to 608 but it would be appreciated that certain steps may not be necessary depending on the results. For example, if the preliminary diameter of the mixing chamber obtained at step 602 is practical and this would create a turbulent-type flow, then there is no need for further estimation at step 603. Likewise, it is the same for the derived water nozzle diameter, and the other steps, as appropriate.

Also, although diameter is used as the preferred dimension to use for measuring the size of the mixing chamber and the water nozzle, other suitable dimensions are envisaged. Further, it is envisaged that the desired emulsifier may have one or more nozzles.

Having now fully described the invention, it should be apparent to one of ordinary skill in the art that many modifications can be made hereto without departing from the scope as claimed.

1. A method of deriving parameters for a desired emulsifier for producing specific water-in-fuel emulsions consistent with emulsions produced by a reference emulsifier, the desired emulsifier and reference emulsifier including a desired mixing chamber and reference mixing chamber respectively for mixing fuel and water, the method comprising
(i) deriving a dimension of the desired mixing chamber for the desired emulsifier based on dimension of the reference mixing chamber of the reference emulsifier, the derived dimension of the desired mixing chamber being one which creates a turbulent type flow at the desired mixing chamber;
(ii) calculating dimensionless water particle size from the derived dimension; and
(iii) deriving nozzle dimension of the desired emulsifier for one or more water nozzles for injecting the water into the fuel at the desired mixing chamber from the calculated dimensionless water particle size.

2. A method according to claim 1, wherein step (i) further comprises
(iv) calculating an initial dimension of the desired mixing chamber for the desired emulsifier based on dimension of the reference mixing chamber of the reference emulsifier, and
(v) verifying if the initial dimension of the desired mixing chamber would create the turbulent-type flow at the desired mixing chamber.

3. A method according to claim 2, wherein if the initial dimension would create the turbulent-type flow, the method includes using the initial dimension as the derived dimension.

4. A method according to claim 2, wherein if the dimension would not create a turbulent-type flow, the method further comprises:
(vi) revising the initial dimension and performing step (v) until a revised dimension is obtained which would create a turbulent-type flow at the desired mixing chamber; and
using the revised dimension as the derived dimension.

5. A method according to claim 2, wherein step (v) includes calculating respective Reynold number of fuel flow of the reference emulsifier and the desired emulsifier.

6. A method according to claim 5, further comprising the step of checking the calculated Reynold numbers against a Moody Diagram to verify if the derived dimension would create a turbulent-type flow.

7. A method according to claim 1, wherein step (iii) includes determining nozzle dimension ratio from an empirical dimension model of the reference emulsifier based on the calculated dimensionless water particle size.

8. A method according to claim 7, further comprising deriving the nozzle dimension from the determined nozzle dimension ratio and the derived dimension.

9. A method according to claim 7, wherein the empirical dimensional model includes a chart of varying nozzle dimension ratios versus varying dimensionless mean water particle sizes derived from the reference emulsifier.

10. A method according to claim 1, wherein the reference dimension of the reference emulsifier includes diameter of the reference mixing chamber and fuel flow rate of the reference mixing chamber.

11. A method according to claim 1, wherein the derive dimension includes diameter of the desired mixing chamber of the desired emulsifier.

12. A method according to claim 1, wherein water content and water particle size of the emulsion to be produced by the desired emulsifier is consistent with those produced by the reference emulsifier.

13. A method according to claim 12, wherein the water content is between 6% and 40% as percentage of water volume to fuel volume and water particle sizes of substantially between 2 and 6 microns.

14. A method according to claim 1, further comprising deriving a number of water nozzles for the desired emulsifier.

15. A method of determining parameters for a desired emulsifier for producing specific water-in-fuel emulsions with an intended fuel flow-rate from a reference parameter map, the reference parameter map being derived from the method of claim 1 and comprises a plurality of values of dimensions of the desired mixing chamber and corresponding desired values of water nozzle dimensions at respective desired fuel-flow rates,
the method comprising:
identifying one of the desired fuel-flow rates which corresponds to the intended fuel flow-rate,
obtaining corresponding values of the dimensions of the desired mixing chamber and water nozzles from the identified fuel-flow rate; and
using these corresponding values as the parameters for the desired emulsifier.

16. A method according to claim 15, wherein the identifying step includes interpolating between two desired fuel-flow rates to identify an interpolated fuel-flow rate which corresponds to the intended fuel flow-rate; and
obtaining corresponding values of the dimensions of the desired mixing chamber and water nozzle from the interpolated fuel-flow rate.

17. An emulsifier for producing water-in-fuel emulsions, comprising
a mixing chamber for mixing fuel and water; the mixing chamber having a diameter of between about 8.00 mm and about 47 mm;
a fuel inlet for directing fuel into the mixing chamber at a rate of about 0.60 m³/hr to about 108 m³/hr; and
one or more nozzles arranged to receive water from a water inlet and to inject the water into the mixing chamber; each of the nozzles having a diameter of between about 0.50 mm and 6.60 mm.

18. An emulsifier according to claim 17, adapted to produce water-in-fuel emulsions with water particles sizes between 6% and 40% as percentage of water volume to fuel volume and water particle sizes of substantially between 2 and 6 microns.

19. An emulsifier according to claim 17, wherein the mixing chamber has a diameter of about 8.00 mm, the or each water nozzle has diameter of about 0.50 mm and the fuel inlet is arranged to direct fuel into the mixing chamber at a rate of about 0.60 m³/hr.

20. An emulsifier according to claim 17, wherein the mixing chamber has a diameter of about 10.00 mm, the or each water nozzle has diameter of 1.10 mm and the fuel inlet is arranged to direct fuel into the mixing chamber at a rate of about 3.00 m³/hr.

21. An emulsifier according to claim 17, wherein the mixing chamber has a diameter of about 12.00 mm, the or each water nozzle has diameter of 1.55 mm and the fuel inlet is arranged to direct fuel into the mixing chamber at a rate of about 6.00 m³/hr.

22. An emulsifier according to claim 17, wherein the mixing chamber has a diameter of about 14.00 mm, the or each water nozzle has diameter of 1.90 mm and the fuel inlet is arranged to direct fuel into the mixing chamber at a rate of about 9.00 m³/hr.

23. An emulsifier according to claim 17, wherein the mixing chamber has a diameter of about 16.00 mm, the or each water nozzle has diameter of 2.20 mm and the fuel inlet is arranged to direct fuel into the mixing chamber at a rate of about 12.00 m³/hr.

24. An emulsifier according to claim 17, wherein the mixing chamber has a diameter of about 18.00 mm, the or each water nozzle has diameter of 2.50 mm and the fuel inlet is arranged to direct fuel into the mixing chamber at a rate of about 15.00 m³/hr.

25. An emulsifier according to claim 17, wherein the mixing chamber has a diameter of about 19.00 mm, the or each water nozzle has diameter of 2.70 mm and the fuel inlet is arranged to direct fuel into the mixing chamber at a rate of about 18.00 m³/hr.

26. An emulsifier according to claim 17, wherein the mixing chamber has a diameter of about 21.00 mm, the or each water nozzle has diameter of 2.95 mm and the fuel inlet is arranged to direct fuel into the mixing chamber at a rate of about 21.00 m³/hr.

27. An emulsifier according to claim 17, wherein the mixing chamber has a diameter of about 26.00 mm, the or each water nozzle has diameter of 3.70 mm and the fuel inlet is arranged to direct fuel into the mixing chamber at a rate of about 33.00 m³/hr.

28. An emulsifier according to claim 17, wherein the mixing chamber has a diameter of about 35.00 mm, the or each water nozzle has diameter of 4.95 mm and the fuel inlet is arranged to direct fuel into the mixing chamber at a rate of about 60.00 m³/hr.

29. An emulsifier according to claim 17, wherein the mixing chamber has a diameter of about 47.00 mm, the or each water nozzle has diameter of 6.60 mm and the fuel inlet is arranged to direct fuel into the mixing chamber at a rate of about 108.00 m³/hr.

30. An emulsifier according to claim 17, wherein the number of water nozzles is four.

31. An emulsifier according to claim 17, wherein the fuel has a viscosity of 2.8 centistokes to 24 centistokes measured after heating.

32. A method of designing and sizing the parts of the desired emulsifier to produce water-in-fuel emulsions more particularly but not exclusively, of water content in the range of 6% to 40% and water particle sizes of 2 to 6 microns, the method comprising the steps of deriving the design and sizes of the parts of the desired emulsifier from a reference emulsifier which has been tested and verified to produce water-in-fuel emulsions of water content in the range of 6% to 40% and water particle sizes of 2 to 6 microns.
